(19) United States
(12) Patent Application Publication
(10) Pub. No.: US 2026/0269918 A1
(43) Pub. Date: Sep. 10, 2026

(54) METHOD AND APPARATUS FOR BEAM MANAGEMENT IN MOBILE COMMUNICATIONS

(71) Applicant: MEDIATEK INC., Hsinchu City (TW)

(72) Inventors: Chien-Hwa HWANG, Hsinchu City (TW); Chia-Hao YU, Hsinchu City (TW); Hsuan-Yi WU, Hsinchu City (TW); Tsung-Wei CHIANG, Hsinchu City (TW); Jiann-Ching GUEY, Hsinchu City (TW)

(21) Appl. No.: 19/166,179

(22) PCT Filed: Jun. 6, 2024
(86) PCT No.: PCT/CN2024/097707

§ 371 Date: Sep. 17, 2025

Related U.S. Application Data
(60) Provisional application No. 63/506,388, filed on Jun. 6, 2023.

(51) Int. Cl. H04B 7/06; H04L 5/00

(52) U.S. Cl. CPC H04B 7/06952; H04L 5/0051

(57) ABSTRACT

Examples pertaining to beam management in mobile communications are described. A user equipment (UE) measures a beamformed reference signal (RS) from a network node and determines channel information regarding at least one channel between the network node and the UE according to the beamformed RS and based on a pre-determined beamformer used for transmitting the beamformed RS. The UE also determines channel feedback information associated with the at least one channel according to the channel information regarding the at least one channel and reports the channel feedback information to the network node.

### CROSS REFERENCE TO RELATED PATENT APPLICATION(S)

The present disclosure is part of a non-provisional application claiming the priority benefit of U.S. Patent Application No. 63/506,388, filed 6 Jun. 2023, the content of which herein being incorporated by reference in its entirety.

### TECHNICAL FIELD

The present disclosure is generally related to beam management in mobile communications and, more particularly, to efficient beam management for massive multiple-input multiple-output (MIMO) in mobile communications.

### BACKGROUND

Unless otherwise indicated herein, approaches described in this section are not prior art to the claims listed below and are not admitted as prior art by inclusion in this section.

Massive multiple-input multiple-output (MIMO) technology has been introduced in 5th Generation (5G), New Radio (NR). The massive MIMO is a wireless transmission technology using massive antennas in a network node or a base station (BS) (such as a next generation Node B (gNB)). In the current NR standards, 32 antenna ports are supported for wireless transmission, and the number of ports may be further increased in forthcoming releases. However, as the number of ports increases, the latency and overhead for beam management will be increased as well.

Accordingly, how to efficiently and accurately perform beam management becomes an important issue for the newly developed wireless communication network. Therefore, there is a need to provide proper schemes to improve beam management for massive MIMO in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to beam management in mobile communications.

In one aspect, a method may involve a communication apparatus measuring a beamformed reference signal (RS) from a network node and determining channel information regarding at least one channel between the network node and the apparatus according to the beamformed RS and based on a pre-determined beamformer used for transmitting the beamformed RS. The method may also involve the communication apparatus determining channel feedback information associated with the at least one channel according to the channel information regarding the at least one channel and reporting the channel feedback information to the network node.

In one aspect, a method may involve a network node transmitting a first beamformed reference signal (RS) to a communication apparatus and receiving first channel feedback information associated with the first beamformed RS from the communication apparatus, wherein the first beamformed RS is a multi-port beamformed RS generated based on a pre-determined beamformer, and wherein the first channel feedback information comprises a spatial domain profile of multiple channels between the network node and the communication apparatus.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example communication system having an example communication apparatus and an example network apparatus in accordance with an implementation of the present disclosure.

FIG. 8 is a diagram depicting an example process in accordance with an implementation of the present disclosure.

FIG. 9 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to beam management in mobile communications. According to the present disclosure, a number of possible solutions may be implemented separately or jointly. That is, although these possible solutions may be described below separately, two or more of these possible solutions may be implemented in one combination or another.

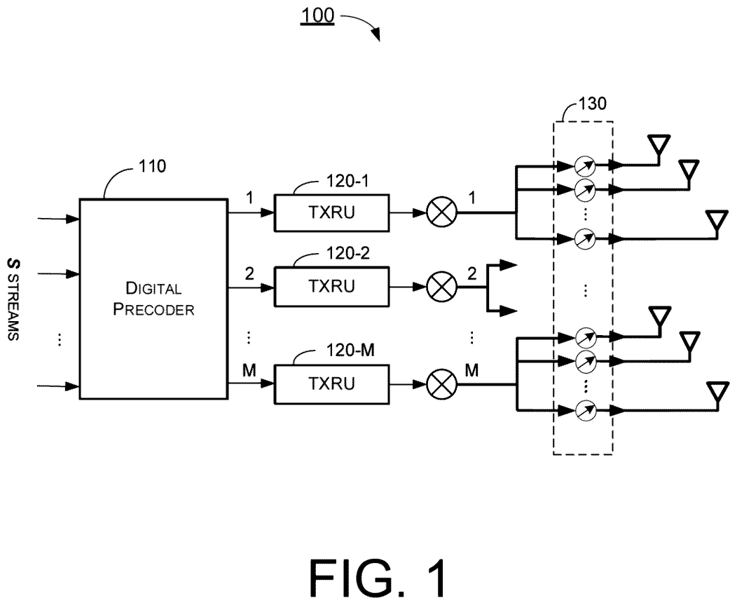

FIG. 1 illustrates an example scenario 100 under schemes in accordance with implementations of the present disclosure. Scenario 100 illustrates an exemplary beamforming architecture of a network apparatus (e.g., a network node, a BS or a gNB). In some implementations, the network node may have a hybrid beamforming architecture, that is, comprising a digital precoder 110 and an array beamformer 130.

The digital precoder 110 performs precoding on S streams and provides the pre-coded streams or signals to a plurality of transmit radio units (TXRUs). The plurality of TXRUs may comprise TXRU 120-1, TXRU 120-2, . . . . TXRU 120-M, where S and M are positive integers.

The array beamformer 130 may be an analog beamformer and may comprise a plurality of phase shifters each being configured to adjust a phase of a signal provided thereto before the signal is transmitted by an antenna element. With the array beamformer 130, one or more beamformed signals can be transmitted by the network node via the associated antenna elements.

In some implementations, an antenna element may be an antenna port or a physical antenna of the network node. In addition, in some implementations, an antenna port may be associated with one or more physical antennas of the network node.

To achieve efficient and accurate beam management, several types of beamformer training are proposed.

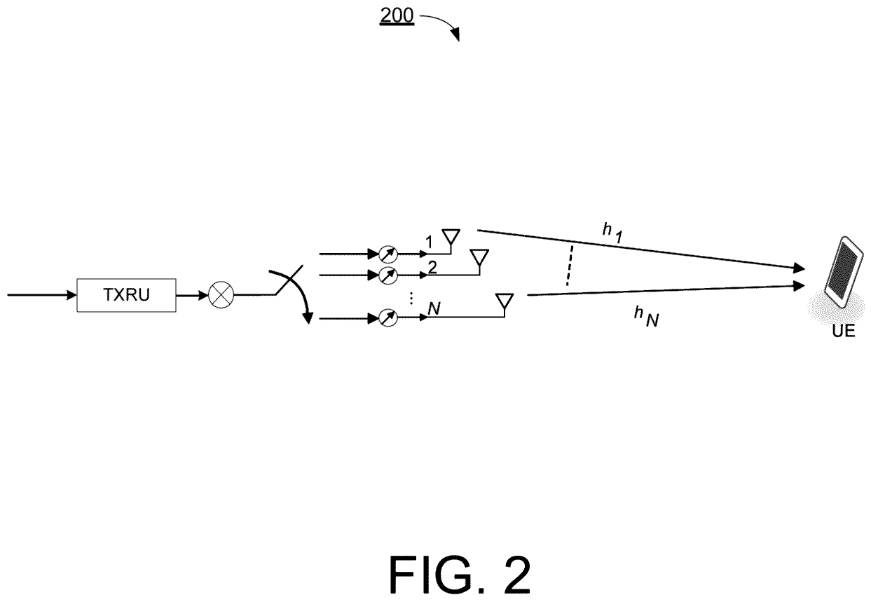

FIG. 2 illustrates an example scenario 200 under schemes in accordance with implementations of the present disclosure. Scenario 200 illustrates an antenna element-wise training, which may be a non-beam sweeping based beam training.

In some implementations, a TXRU may be associated with a subarray which needs to determine a beamformer for data transmission. Assuming that there are N antenna elements in a subarray or a subset, where N is a positive integer. The TXRU may be sequentially connected to one of the N antenna elements as well as its associated phase shifter, and may transmit at least one training signal (or pilot) to implement the corresponding training.

In some implementations, during the training phase, one TXRU may be connected to only one (or a subset) of antenna elements in an associated array or subarray. In some implementations, there may be a time division multiplexed (TDM-ed) multiplexing operation between the TXRU and antenna elements of the subarray, so that different antenna elements may be connected to the TXRU at different time.

In some implementations, a communication apparatus (e.g., a UE) receiving the training signals or pilots may measure the received training signals or pilots and determine the channel information regarding at least one channel between the network node and the UE according to the training signals or pilots.

In some implementations, the channel information h associated with the channels between the antenna elements of the network node and the receive (RX) antenna of the UE may be measured (and determined or estimated) by the UE, and may be expressed as h=[h₁ . . . h_{N}]^{T}, where h₁ may represent the channel information of a channel between the first antenna element of the network node and the RX antenna of the UE, h_{N} may represent the channel information of a channel between the N-th antenna element of the network node and the RX antenna of the UE, and so on.

In some implementations, the UE may report the channel information h to the network node for the network node to derive or determine the beamformer for data transmission (e.g., the amount of phase shift to be performed by one or more phase shifters in the array beamformer 130).

In some implementations, the UE may further determine channel feedback information associated with the channels according to the channel information and report the channel feedback information to the network node for the network node to derive or determine the beamformer for data transmission.

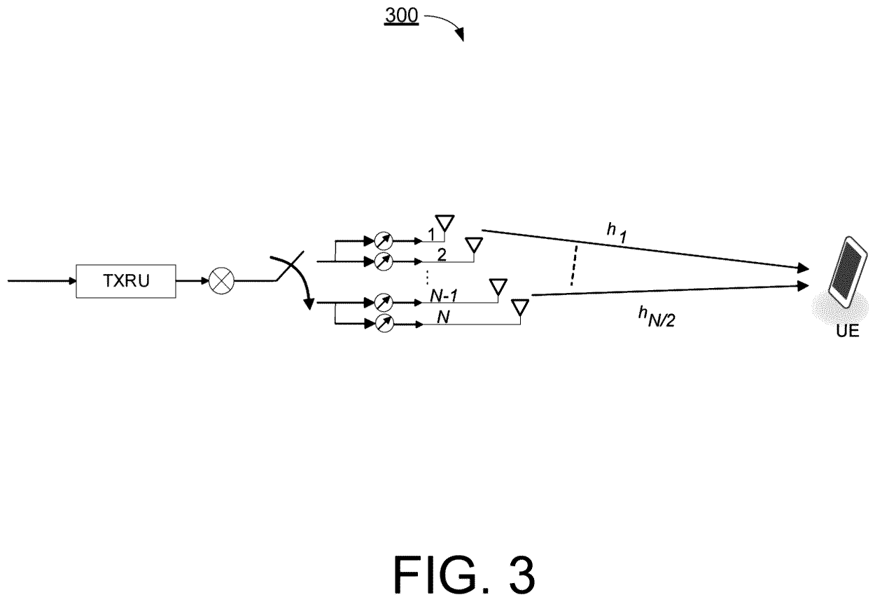

FIG. 3 illustrates an example scenario 300 under schemes in accordance with implementations of the present disclosure. Scenario 300 illustrates an antenna subset-wise training, which may be a non-beam sweeping based beam training.

A TXRU may be associated with a subarray of N antenna elements which needs to determine a beamformer for data transmission, where N is a positive integer. In some implementations, there may be two antenna elements in a subset, and the training and measurement may be performed per antenna subset in a subarray. The TXRU may be sequentially connected to one subset of antenna elements as well as their associated phase shifters, and may transmit at least one training signal (or pilot) to implement the corresponding training.

In some implementations, during the training phase, one TXRU may be connected to one subset of antenna elements in an associated array or subarray. In some implementations, there may be a TDM-ed multiplexing operation between the TXRU and antenna elements of the subarray, so that different subsets of antenna elements may be connected to the TXRU at different time.

In some implementations, the beamformer for each antenna subset in the training phase may be determined by network planning, and may be transparent to UE.

In some implementations, the UE receiving the training signals or pilots may measure the received training signals or pilots and determine the channel information regarding at least one channel between the network node and the UE according to the training signals or pilots. In some implementations, the UE may report the channel information to the network node for the network node to derive or determine the beamformer for data transmission.

In some implementations, the UE may further determine channel feedback information associated with the channels according to the channel information and report the channel feedback information to the network node for the network node to derive or determine the beamformer for data transmission.

In some implementations, the number of antenna elements in a subset may be one as illustrated in FIG. 2, two as illustrated in FIG. 3 or more than two. In some implementations, the number of antenna elements in a subset and/or the number of antenna subsets may depend on network configuration for measurement resource.

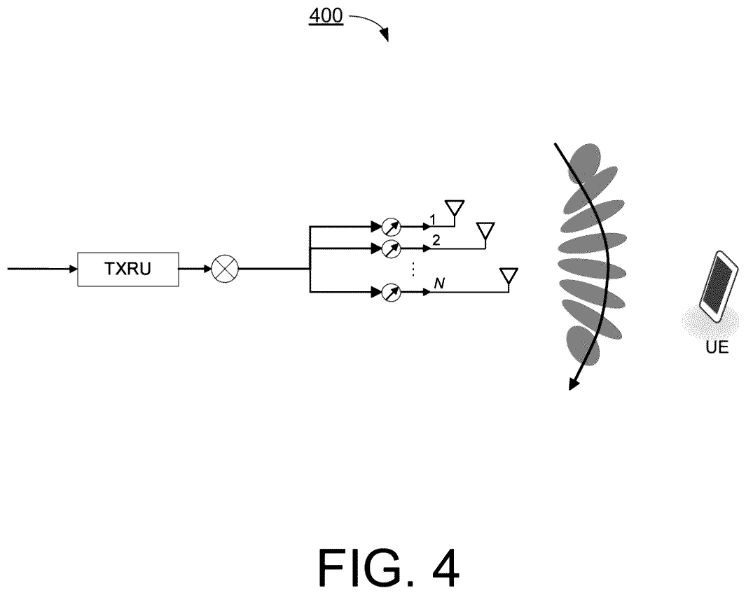

FIG. 4 illustrates an example scenario 400 under schemes in accordance with implementations of the present disclosure. Scenario 400 illustrates a beam-wise training.

In some implementations, one TXRU may be associated with a subarray, which needs to determine a beamformer for data transmission, and may transmit at least one training signal (or pilot) to implement the corresponding training. In some implementations, during beam training, pre-defined beamformers may be applied for training signal or pilot transmission. The UE may have knowledge of the pre-defined beamformers, which may be (pre-) specified or (pre-) configured.

In some implementations, the UE receiving the training signals or the pilots may measure the received training signals or pilot and determine the channel information regarding at least one channel between the network node and the UE according to the training signals or pilots. In some implementations, the UE may report the channel information to the network node for the network node to derive or determine the beamformer for data transmission.

In some implementations, the UE may further determine channel feedback information associated with the channels according to the channel information and report the channel feedback information to the network node for the network node to derive or determine the beamformer for data transmission.

With respect to the UE, in some implementations, the UE may measure a beamformed reference signal (RS) from the network node and determine channel information regarding at least one channel between the network node and the UE according to the beamformed RS and based on a pre-determined beamformer used for transmitting the beamformed RS. In some implementations, the UE may determine channel feedback information associated with the at least one channel according to the channel information regarding the at least one channel and report the channel feedback information to the network node. In some implementations, the pre-determined beamformer is known to the UE. For example, the pre-determined beamformer may be configured to the UE by the network node via a higher layer signaling (e.g., RRC signaling). In another example, the pre-determined beamformer may be pre-defined in 3^{rd} Generation Partnership Project (3GPP) specifications. One or more beamformers may be specified in 3GPP specifications for some conditions or scenarios. The UE may have the knowledge of which beamformer should be used according to 3GPP specifications.

In some implementations, the beamformed RS may be the aforementioned training signal or pilot transmitted by a single antenna element as depicted in FIG. 2 or transmitted by a subset of antenna elements as depicted in FIG. 3 and FIG. 4. Note that the number of antenna elements in a subset may be one, two or more than two, and the scope of the present disclosure is not limited to any specific number.

In some implementations, assuming that the observed reception g (e.g., the received signals or the measurements of the UE) may be expressed as: g=[g₁, g₂, . . . , g_{N}] and the pre-determined or pre-defined beamformer B may be expressed as: B=[b₁, b₂, . . . , b_{N}], where bⱼ represents the j-th pre-determined or pre-defined beamformer and may be expressed as: b=[b₁ⱼ, b₂ⱼ, . . . , b_{Nj}]. With the knowledge of the pre-determined or pre-defined beamformer, the channel information may be derived based on the following equation:

$$g = {h}^{T} * [ {b}_{1} , {b}_{2} , … , {b}_{N} ] = h * B \qquad Eq . ( 1 )$$

In some implementations, the channel information may be derived by least square estimation based on the knowledge of g(f) and B as the following equation:

$$\hat{h} ( f ) = g ( f ) {{B}^{H} ( {BB}^{H} )}^{- 1} \qquad Eq . ( 2 )$$

where f is the frequency index whose resolution may be flexibly designed (e.g., f may be a subcarrier index or a sub-band index), the g(f) represents the received signal (measurements) and B is the pre-defined beamformers used for transmitting signal for the receiver to observe the g(f).

In some implementations, the beamformed RS may be a multi-port beamformed RS, and wherein the channel information regarding the at least one channel may comprise information regarding multiple channels between the network node and the UE.

In some implementations, one ‘port’ may be associated with a channel between a Tx-RX pair, and ‘multi-port’ may be associated with multiple channels (multiple Tx-Rx pairs) that can be differentiated by a receiver. In addition, in some implementations, one port may be mapped to one or a subset of antenna elements, as depicted in FIG. 2, FIG. 3 and FIG. 4, while different ports may be mapped to different or the same set or subset of antenna elements.

In some implementations, the channel information regarding the at least one channel may be determined based on a first beamformer applied to a first subset of antenna elements (or antenna ports) of the network node and associated with a first port of the multi-port beamformed RS.

In some implementations, the channel information regarding the at least one channel may be determined based on a first beamformer and a second beamformer, wherein the first beamformer is applied to a first subset of antenna elements (or antenna ports) of the network node and associated with a first port of the multi-port beamformed RS, and the second beamformer is applied to a second subset of antenna elements (or antenna ports) of the network node and associated with a second port of the multi-port beamformed RS.

In some implementations, the first beamformer may be different from the second beamformer.

In some implementations, the first or second subset of antenna elements may comprise all antenna elements whose channel information is to be considered for deriving the channel feedback information. In some implementations, the first or second subset of antenna elements may comprise part of all antenna elements whose channel information is to be considered for deriving the channel feedback information. In some implementations, the first or second port may comprise a subset of all antenna elements whose channel information is to be considered for deriving the channel feedback information, where the subset may comprise one or more than one antenna elements.

In some implementations, the first subset of antenna elements and the second subset of antenna elements may be identical subset of antenna elements within an antenna array.

In some implementations, the first beamformer and the second beamformer may be known to the UE. The UE may derive the channel information based on equation Eq. (1) and/or Eq. (2).

In some implementations, the first beamformer and/or the second beamformer may be unknown (i.e., transparent) to the UE. For example, the network node may use different beams for transmitting different reference signals (RSs), and the UE may provide feedback by indicating which RS provides the best received quality (thus, providing beam information). In some implementations, the UE may also provide the reference signal received power (RSRP) of the received signal or received channel gain.

For another example, the first beamformer and/or the second beamformer may be a dummy beamformer, such as an identity beamformer which may be a matrix with only “1” in diagonal elements, while other elements being zeros.

In some implementations, the first port and the second port of the multi-port beamformed RS may be scheduled on orthogonal resources. In some implementations, the orthogonal resources may comprise at least one of TDM-ed resources, frequency division multiplexed (FDM-ed) resources and code division multiplexed (CDM-ed) resources.

In some implementations, measurement resources may be orthogonal resources for different antenna elements, different subsets of antenna elements or different pre-defined beamformer. In some implementations, different ports of the multi-port beamformed RS may be FDM-ed and/or TDM-ed resources.

In some implementations, orthogonal resources may be TDM-ed resources where transmissions associated with different antenna elements, different subsets of antenna elements or all antenna elements in a subarray with pre-defined beamformer may take place in different time, e.g., different symbols and/or different slots. In one example, TDM-ed resources may be treated as multi-port resources and UE may measure and extract desired information based on the multi-port resources.

In some implementations, orthogonal resources may be FDM-ed resources where transmissions associated with different antenna elements, different subsets of antenna elements or all elements in a subarray with pre-defined beamformer may take place in different frequency elements, e.g., different offsets in comb structure. In one example, there may be more than one TXRU, and the TXRUs may be individually connected to different antenna elements or subsets of antenna elements, or connected to all elements in a subarray with pre-defined beamformer.

In some implementations, orthogonal resources may be a hybrid form of TDM, FDM, and/or CDM.

In some implementations, the beamformed RS may be a first multi-port beamformed RS, the channel information regarding the at least one channel may be first channel information determined according to the first multi-port beamformed RS and based on a first beamformer associated with the first multi-port beamformed RS, and the channel feedback information may be first channel feedback information determined according to the first channel information. In some implementations, the UE may further measure a second multi-port beamformed RS from the network node and determine second channel information regarding at least one channel between the network node and the UE according to the second multi-port beamformed RS and based on a second beamformer associated with the second multi-port beamformed RS.

In addition, in some implementations, the UE may determine second channel feedback information associated with the at least one channel according to the second channel information and report the second channel feedback information to the network node. In some implementations, the first beamformer and the second beamformer may be different.

In some implementations, a size of a first antenna array of the network node used for transmitting the first multi-port beamformed RS and a size of a second antenna array of the network node used for transmitting the second multi-port beamformed RS may be different.

In addition, in some implementations, a number of ports associated with the first multi-port beamformed RS and a number of ports associated with the second multi-port beamformed RS may be the same. In some implementations, a number of ports associated with the first multi-port beamformed RS and a number of ports associated with the second multi-port beamformed RS may be different.

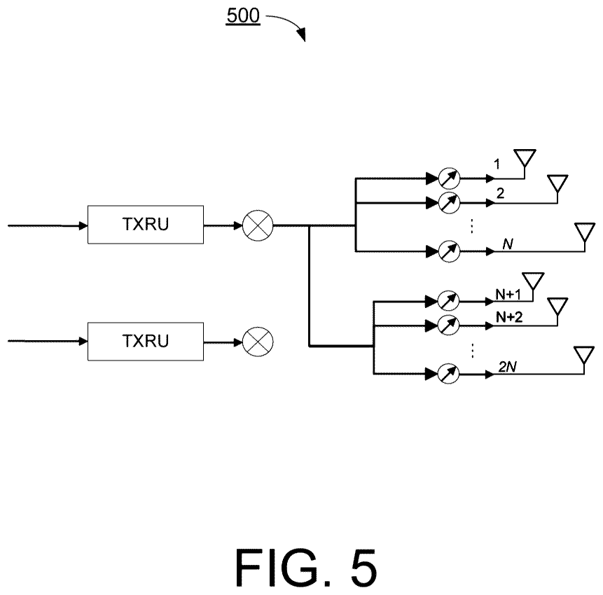

In some implementations, one TXRU may be associated with or connected to more than one subarray to form a larger subarray. FIG. 5 illustrates an example scenario 500 under schemes in accordance with implementations of the present disclosure. Scenario 500 illustrates one TXRU connected to two subarrays of N antenna elements to form a larger subarray with 2N antenna elements.

In some implementations, the transmissions may be divided into two phases, including the training phase and the data transmission phase. In the training phase, an array beamformer for the resultant larger subarray is determined. In the data transmission phase, the determined array beamformer is applied on the resultant larger subarray for data transmission.

In some implementations, in the training phase, the training may assume the resultant larger subarray as depicted in FIG. 5 and apply the methods as introduced above (for example, the antenna element-wise training, the antenna subset-wise training, the beam-wise training and/or the multi-port beamformed RS training) to determine the array beamformer.

In some implementations, the training may assume a smaller subarray connection and may be carried out by more than one TXRU.

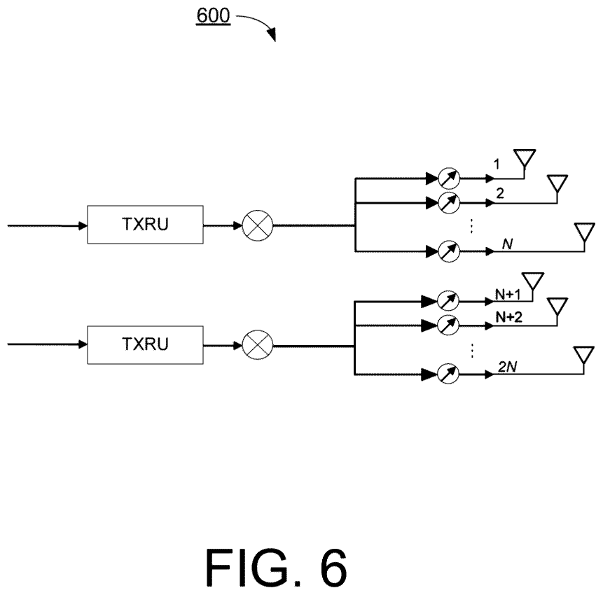

FIG. 6 illustrates an example scenario 600 under schemes in accordance with implementations of the present disclosure. Scenario 600 illustrates two TXRUs each being connected to one subarray of N antenna elements, to train a larger subarray with the 2N antenna elements via the two TXRUs.

In some implementations, the UE may be provided with 2N-port RS for measurement. The UE may report channel information or channel feedback information regarding the channel associated with the 2N-port RS based on the measurements as the methods introduced above.

In addition, the measurement resources may be orthogonal resources as introduced above. For example, the orthogonal resources may be hybrid TDM and FDM, where the resources associated with the same TXRU may be TDM-ed and the resources associated with different TXRUs may be FDM-ed. In some implementations, the orthogonal resources may be further CDM-ed on FDM-ed resources.

In some implementations, the channel feedback information may comprise at least information related to (deriving) channel spatial domain profile. In some implementations, the channel feedback information may comprise at least one of an indication of at least one Direct Fourier Transform (DFT) vector, an indication of the at least one DFT vector with its associated channel gain, an indication of the at least one DFT vector with co-phasing information on cross-polarization antennas and an angle of departure (AoD) associated with the at least one channel.

In some implementations, the channel feedback information reported by the UE may be an indication of a DFT beamformer which may be one-dimensional or two-dimensional, or one vector from an oversampled DFT beamformers. In some implementations, the DFT beamformer may be determined based on (pre-) configuration.

In some implementations, the channel feedback information reported by the UE may be a wideband precoding matrix indicator (PMI) associated with a codebook. The wideband PMI may have same amplitude for each antenna subsets or antenna elements. In some implementations, the channel feedback information reported by the UE may be a collection of AoD.

With respect to the network node, in some implementations, the network node may transmit a first beamformed RS to a communication apparatus (e.g., a UE) and receive first channel feedback information associated with the first beamformed RS from the communication apparatus. In some implementations, the first channel feedback information may comprise a spatial domain profile of at least one channel between the network node and the communication apparatus.

In some implementations, the first beamformed RS may be a multi-port beamformed RS generated based on one or more pre-determined beamformers known to the communication apparatus, and the first channel feedback information may comprise the spatial domain profile of multiple channels between the network node and the communication apparatus.

In some implementations, the network node may apply a first beamformer to a first subset of antenna elements and apply a second beamformer to a second subset of antenna elements. In some implementations, the first beamformer may be associated with a first port of the multi-port beamformed RS and the second beamformer may be associated with a second port of the multi-port beamformed RS, and the first beamformer may be different from the second beamformer.

In some implementations, the first subset of antenna elements and the second subset of antenna elements may be identical subset of antenna elements within an antenna array.

In some implementations, at least one antenna element in the first subset of antenna elements may be different from at least one antenna element in the second subset of antenna elements. In some implementations, the antenna element(s) in different subsets may be different antenna element(s).

In some implementations, the network node may schedule the first port and the second port of the multi-port beamformed RS on orthogonal resources. In some implementations, the orthogonal resources may comprise at least one of time division multiplexed resources, frequency division multiplexed resources and code division multiplexed resources.

In some implementations, the first beamformed RS may be a first multi-port beamformed RS and the first channel feedback information may be associated with the first multi-port beamformed RS. The network node may further transmit a second multi-port beamformed RS to the communication apparatus and receive second channel feedback information associated with the second multi-port beamformed RS from the communication apparatus. In some implementations, a first beamformer associated with the first multi-port beamformed RS and a second beamformer associated with the second multi-port beamformed RS may be different.

In some implementations, a number of ports associated with the first multi-port beamformed RS and a number of ports associated with the second multi-port beamformed RS may be different.

In some implementations, a size of a first antenna array used for transmitting the first multi-port beamformed RS and a size of a second antenna array used for transmitting the second multi-port beamformed RS may be different.

In some implementations, the first multi-port beamformed RS and the second multi-port beamformed RS may be transmitted via a same TXRU of the network node.

In some implementations, the first multi-port beamformed RS and the second multi-port beamformed RS may be transmitted via different TXRUs of the network node.

In some implementations, the spatial domain profile may comprise at least one of an indication of at least one DFT vector, an indication of the at least one DFT vector with its associated channel gain, an indication of the at least one DFT vector with co-phasing information on cross-polarization antennas and an angle of departure associated with the at least one channel.

### Illustrative Implementations

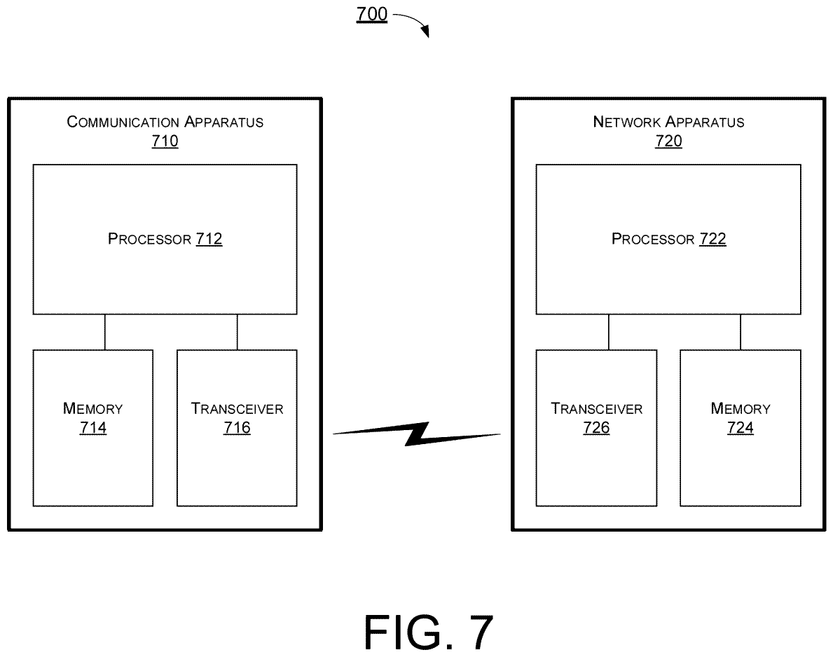

FIG. 7 illustrates an example communication system 700 having an example communication apparatus 710 and an example network apparatus 720 in accordance with an implementation of the present disclosure. Each of the communication apparatus 710 and the network apparatus 720 may perform various functions to implement schemes, techniques, processes and methods described herein pertaining to beam management with respect to user equipment and network apparatus in mobile communications, including scenarios/schemes described above as well as the process 800 and the process 900 described below.

The communication apparatus 710 may be a part of an electronic apparatus, which may be a UE such as a portable or mobile apparatus, a wearable apparatus, a wireless communication apparatus or a computing apparatus. For instance, the communication apparatus 710 may be implemented in a smartphone, a smartwatch, a personal digital assistant, a digital camera, or a computing equipment such as a tablet computer, a laptop computer or a notebook computer. The communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 710 may be implemented in a smart thermostat, a smart fridge, a smart door lock, a wireless speaker or a home control center. Alternatively, the communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 710 may include at least some of those components shown in FIG. 7 such as a processor 712, for example. The communication apparatus 710 may further include one or more other components not pertinent to the proposed scheme of the present disclosure (e.g., internal power supply, display device and/or user interface device), and, thus, such component(s) of the communication apparatus 710 are neither shown in FIG. 7 nor described below in the interest of simplicity and brevity.

The network apparatus 720 may be a part of a network device, which may be a network node such as a satellite, a base station, a small cell, a router or a gateway. For instance, the network apparatus 720 may be implemented in an eNodeB in an LTE network, in a gNB in a 5G/NR, IoT, NB-IoT or IIoT network or in a satellite or base station in a 6G network. Alternatively, the network apparatus 720 may be implemented in the form of one or more IC chips such as, for example and without limitation, one or more single-core processors, one or more multi-core processors, or one or more RISC or CISC processors. The network apparatus 720 may include at least some of those components shown in FIG. 7 such as a processor 722, for example. The network apparatus 720 may further include one or more other components not pertinent to the proposed scheme of the present disclosure (e.g., internal power supply, display device and/or user interface device), and, thus, such component(s) of the network apparatus 720 are neither shown in FIG. 7 nor described below in the interest of simplicity and brevity.

In one aspect, each of the processor 712 and the processor 722 may be implemented in the form of one or more single-core processors, one or more multi-core processors, or one or more CISC processors. That is, even though a singular term “a processor” is used herein to refer to the processor 712 and the processor 722, each of the processor 712 and the processor 722 may include multiple processors in some implementations and a single processor in other implementations in accordance with the present disclosure. In another aspect, each of the processor 712 and the processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 712 and the processor 722 is a special-purpose machine specifically designed, arranged and configured to perform specific tasks including autonomous reliability enhancements in a device (e.g., as represented by the communication apparatus 710) and a network (e.g., as represented by the network apparatus 720) in accordance with various implementations of the present disclosure.

In some implementations, the communication apparatus 710 may also include a transceiver 716 coupled to the processor 712 and capable of wirelessly transmitting and receiving data. In some implementations, the communication apparatus 710 may further include a memory 714 coupled to the processor 712 and capable of being accessed by the processor 712 and storing data therein. In some implementations, the network apparatus 720 may also include a transceiver 726 coupled to the processor 722 and capable of wirelessly transmitting and receiving data. In some implementations, the network apparatus 720 may have a plurality of physical antennas which associates with a plurality of antenna ports. In some implementations, the network apparatus 720 may include a digital precoder (such as the digital precoder depicted in FIG. 1), one or more TXRU (such as the TXRUs depicted in FIG. 1) and a beamformer (such as the array beamformer depicted in FIG. 1).

In some implementations, the network apparatus 720 may further include a memory 724 coupled to processor 722 and capable of being accessed by the processor 722 and storing data therein. Accordingly, the communication apparatus 710 and the network apparatus 720 may wirelessly communicate with each other via the transceiver 716 and the transceiver 726, respectively. To aid better understanding, the following description of the operations, functionalities and capabilities of each of the communication apparatus 710 and the network apparatus 720 is provided in the context of a mobile communication environment in which the communication apparatus 710 is implemented in or as a communication apparatus or a UE and the network apparatus 720 is implemented in or as a network node or a network device of a communication network.

In some implementations, in the operations of beam management, the processor 712 of the communication apparatus 710 may measure a beamformed RS from a network node (e.g., the network apparatus 720) and determine channel information regarding at least one channel between the network node and the communication apparatus 710 according to the beamformed RS and based on one or more pre-determined beamformers known to the processor 712 and used for transmitting the beamformed RS. The processor 712 may further determine channel feedback information associated with the at least one channel according to the channel information regarding the at least one channel and report the channel feedback information to the network node.

In some implementations, the beamformed RS may be a multi-port beamformed RS, and the channel information regarding the at least one channel may comprise information regarding multiple channels between the network node and the communication apparatus 710.

In some implementations, the channel information regarding the at least one channel may be determined based on a first beamformer applied to a first subset of antenna elements of the network node and associated with a first port of the multi-port beamformed RS and a second beamformer applied to a second subset of antenna elements of the network node and associated with a second port of the multi-port beamformed RS.

In some implementations, the first beamformer may be different from the second beamformer.

In some implementations, the first subset of antenna elements and the second subset of antenna elements may be identical subset of antenna elements within an antenna array.

In some implementations, the first port and the second port of the multi-port beamformed RS may be scheduled on orthogonal resources.

In some implementations, the orthogonal resources may comprise at least one of time division multiplexed resources, frequency division multiplexed resources and code division multiplexed resources.

In some implementations, the beamformed RS may be a first multi-port beamformed RS, the channel information regarding the at least one channel may be first channel information determined according to the first multi-port beamformed RS and based on a first beamformer associated with the first multi-port beamformed RS, and the channel feedback information may be first channel feedback information determined according to the first channel information. The processor 712 may measure a second multi-port beamformed RS from the network nod and determine second channel information regarding at least one channel between the network node and the communication apparatus 710 according to the second multi-port beamformed RS and based on a second beamformer associated with the second multi-port beamformed RS.

In some implementations, the processor 712 may further determine second channel feedback information associated with the at least one channel according to the second channel information and report the second channel feedback information to the network node. In some implementations, the first beamformer and the second beamformer may be different.

In some implementations, a number of ports associated with the first multi-port beamformed RS and a number of ports associated with the second multi-port beamformed RS may be different.

In some implementations, the first subset of antenna elements and the second subset of antenna elements may be identical subset of antenna elements within an antenna array.

In some implementations, the channel feedback information may comprise at least one of an indication of at least one DFT vector, an indication of the at least one DFT vector with its associated channel gain, an indication of the at least one DFT vector with co-phasing information on cross-polarization antennas and an angle of departure associated with the at least one channel.

In some implementations, in the operations of beam management with respect to a network node, the processor 722 of the network apparatus 720 may transmit a first beamformed RS to a communication apparatus (e.g., the communication apparatus 710) and receive first channel feedback information associated with the first beamformed RS from the communication apparatus. In some implementations, the first channel feedback information may comprise a spatial domain profile of at least one channel between the network apparatus 720 and the communication apparatus.

In some implementations, the first beamformed RS may be a multi-port beamformed RS generated based on one or more pre-determined beamformers known to the communication apparatus, and the first channel feedback information may comprise the spatial domain profile of multiple channels between the network apparatus 720 and the communication apparatus.

In some implementations, the processor 722 may apply a first beamformer to a first subset of antenna elements and apply a second beamformer to a second subset of antenna elements. In some implementations, the first beamformer may be associated with a first port of the multi-port beamformed RS and the second beamformer may be associated with a second port of the multi-port beamformed RS, and the first beamformer may be different from the second beamformer.

In some implementations, the first subset of antenna elements and the second subset of antenna elements may be identical subset of antenna elements within an antenna array.

In some implementations, at least one antenna element in the first subset of antenna elements may be different from at least one antenna element in the second subset of antenna elements. In some implementations, the antenna element(s) in different subsets may be different antenna element(s).

In some implementations, the processor 722 may schedule the first port and the second port of the multi-port beamformed RS on orthogonal resources. In some implementations, the orthogonal resources may comprise at least one of time division multiplexed resources, frequency division multiplexed resources and code division multiplexed resources.

In some implementations, the first beamformed RS may be a first multi-port beamformed RS and the first channel feedback information may be associated with the first multi-port beamformed RS. The processor 722 may further transmit a second multi-port beamformed RS to the communication apparatus and receive second channel feedback information associated with the second multi-port beamformed RS from the communication apparatus. In some implementations, a first beamformer associated with the first multi-port beamformed RS and a second beamformer associated with the second multi-port beamformed RS may be different.

In some implementations, a number of ports associated with the first multi-port beamformed RS and a number of ports associated with the second multi-port beamformed RS may be different.

In some implementations, a size of a first antenna array used for transmitting the first multi-port beamformed RS and a size of a second antenna array used for transmitting the second multi-port beamformed RS may be different.

In some implementations, the first multi-port beamformed RS and the second multi-port beamformed RS may be transmitted via a same TXRU of the network apparatus 720.

In some implementations, the first multi-port beamformed RS and the second multi-port beamformed RS may be transmitted via different TXRUs of the network apparatus 720.

In some implementations, the spatial domain profile may comprise at least one of an indication of at least one DFT vector, an indication of the at least one DFT vector with its associated channel gain, an indication of the at least one DFT vector with co-phasing information on cross-polarization antennas and an angle of departure associated with the at least one channel.

### Illustrative Processes

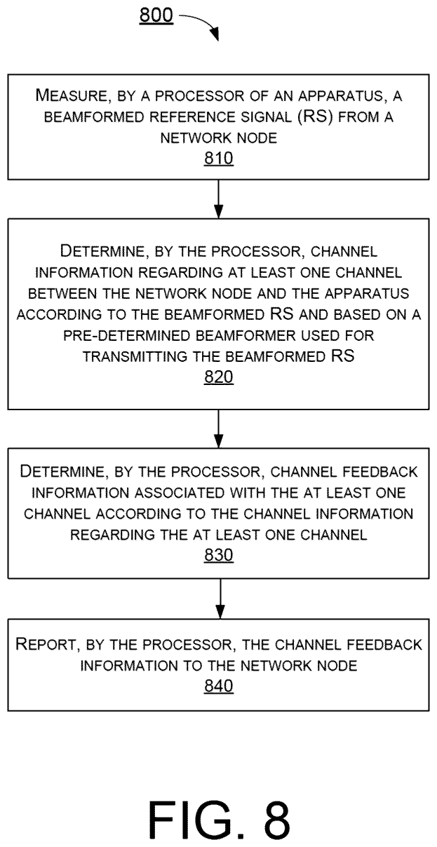

FIG. 8 illustrates an example process 800 in accordance with an implementation of the present disclosure. The process 800 may be an example implementation of above scenarios/schemes, whether partially or completely, with respect to beam management in accordance with the present disclosure. The process 800 may represent an aspect of implementation of features of the communication apparatus 710. The process 800 may include one or more operations, actions, or functions as illustrated by one or more of blocks 810, 820, 830 and 840. Although illustrated as discrete blocks, various blocks of the process 800 may be divided into additional blocks, combined into fewer blocks, or eliminated, depending on the desired implementation. Moreover, the blocks of the process 800 may be executed in the order shown in FIG. 8 or, alternatively, in a different order. The process 800 may be implemented by the communication apparatus 710 or any suitable UE or machine type devices. Solely for illustrative purposes and without limitation, the process 800 is described below in the context of the communication apparatus 710. The process 800 may begin at block 810.

At 810, the process 800 may involve the processor 712 of the communication apparatus 710 measuring a beamformed RS from a network node (e.g., the network apparatus 720). The process 800 may proceed from 810 to 820.

At 820, the process 800 may involve the processor 712 determining channel information regarding at least one channel between the network node and the communication apparatus 710 according to the beamformed RS and based on a pre-determined beamformer used for transmitting the beamformed RS. The process 800 may proceed from 820 to 830.

At 830, the process 800 may involve the processor 712 determining channel feedback information associated with the at least one channel according to the channel information regarding the at least one channel. The process 800 may proceed from 830 to 840.

At 840, the process 800 may involve the processor 712 reporting, the channel feedback information to the network node.

In some implementations, the beamformed RS may be a multi-port beamformed RS, and the channel information regarding the at least one channel may comprise information regarding multiple channels between the network node and the communication apparatus 710.

In some implementations, the channel information regarding the at least one channel may be determined based on a first beamformer applied to a first subset of antenna elements of the network node and associated with a first port of the multi-port beamformed RS and a second beamformer applied to a second subset of antenna elements of the network node and associated with a second port of the multi-port beamformed RS.

In some implementations, the first beamformer may be different from the second beamformer.

In some implementations, the first subset of antenna elements and the second subset of antenna elements may be identical subset of antenna elements within an antenna array.

In some implementations, the first port and the second port of the multi-port beamformed RS may be scheduled on orthogonal resources.

In some implementations, the orthogonal resources may comprise at least one of time division multiplexed resources, frequency division multiplexed resources and code division multiplexed resources.

In some implementations, the beamformed RS may be a first multi-port beamformed RS, the channel information regarding the at least one channel may be first channel information determined according to the first multi-port beamformed RS and based on a first beamformer associated with the first multi-port beamformed RS, and the channel feedback information may be first channel feedback information determined according to the first channel information. The process 800 may involve the processor 712 measuring a second multi-port beamformed RS from the network nod and determining second channel information regarding at least one channel between the network node and the communication apparatus 710 according to the second multi-port beamformed RS and based on a second beamformer associated with the second multi-port beamformed RS.

In some implementations, the process 800 may further involve the processor 712 determining second channel feedback information associated with the at least one channel according to the second channel information and reporting the second channel feedback information to the network node. In some implementations, the first beamformer and the second beamformer may be different.

In some implementations, a size of a first antenna array of the network node used for transmitting the first multi-port beamformed RS and a size of a second antenna array of the network node used for transmitting the second multi-port beamformed RS may be different.

In some implementations, a number of ports associated with the first multi-port beamformed RS and a number of ports associated with the second multi-port beamformed RS may be different.

In some implementations, the channel feedback information may comprise at least one of an indication of at least one DFT vector, an indication of the at least one DFT vector with its associated channel gain, an indication of the at least one DFT vector with co-phasing information on cross-polarization antennas and an angle of departure associated with the at least one channel.

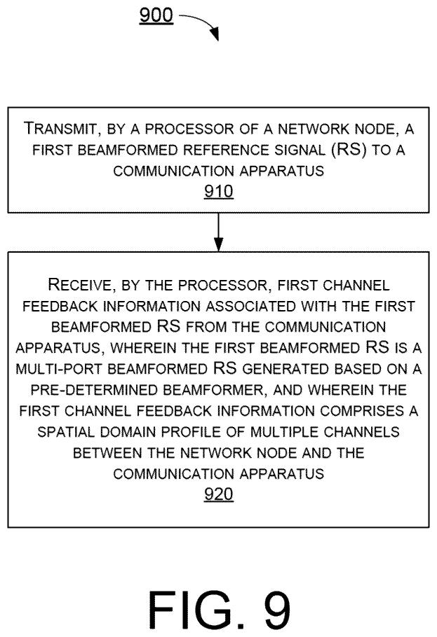

FIG. 9 depicting an example process 900 in accordance with an implementation of the present disclosure. The process 900 may be an example implementation of above scenarios/schemes, whether partially or completely, with respect to beam management in accordance with the present disclosure. The process 900 may represent an aspect of implementation of features of the network apparatus 720. The process 900 may include one or more operations, actions, or functions as illustrated by one or more of blocks 910 and 920. Although illustrated as discrete blocks, various blocks of the process 900 may be divided into additional blocks, combined into fewer blocks, or eliminated, depending on the desired implementation. Moreover, the blocks of the process 900 may be executed in the order shown in FIG. 9 or, alternatively, in a different order. The process 900 may be implemented by the network apparatus 720 or any suitable network device or network node. Solely for illustrative purposes and without limitation, the process 900 is described below in the context of the network apparatus 720. The process 900 may begin at block 910.

At 910, the process 900 may involve the processor 722 of the network apparatus 720 transmitting a first beamformed RS to a communication apparatus (e.g., the communication apparatus 710). The process 900 may proceed from 910 to 920.

At 920, the process 900 may involve the processor 722 receiving first channel feedback information associated with the first beamformed RS from the communication apparatus. The first channel feedback information may be a multi-port beamformed RS generated based on a pre-determined beamformer, and the first channel feedback information may comprise a spatial domain profile of multiple channels between the network apparatus 720 and the communication apparatus.

In some implementations, the process 900 may involve the processor 722 applying a first beamformer to a first subset of antenna elements and applying a second beamformer to a second subset of antenna elements. In some implementations, the first beamformer may be associated with a first port of the multi-port beamformed RS and the second beamformer may be associated with a second port of the multi-port beamformed RS, and the first beamformer may be different from the second beamformer.

In some implementations, the first subset of antenna elements and the second subset of antenna elements may be identical subset of antenna elements within an antenna array.

In some implementations, at least one antenna element in the first subset of antenna elements may be different from at least one antenna element in the second subset of antenna elements. In some implementations, the antenna element(s) in different subsets may be different antenna element(s).

In some implementations, the process 900 may involve the processor 722 scheduling the first port and the second port of the multi-port beamformed RS on orthogonal resources. In some implementations, the orthogonal resources may comprise at least one of time division multiplexed resources, frequency division multiplexed resources and code division multiplexed resources.

In some implementations, the first beamformed RS may be a first multi-port beamformed RS and the first channel feedback information may be associated with the first multi-port beamformed RS. The process 900 may further involve the processor 722 transmitting a second multi-port beamformed RS to the communication apparatus and receiving second channel feedback information associated with the second multi-port beamformed RS from the communication apparatus. In some implementations, a first beamformer associated with the first multi-port beamformed RS and a second beamformer associated with the second multi-port beamformed RS may be different.

In some implementations, a size of a first antenna array used for transmitting the first multi-port beamformed RS and a size of a second antenna array used for transmitting the second multi-port beamformed RS may be different.

In some implementations, a number of ports associated with the first multi-port beamformed RS and a number of ports associated with the second multi-port beamformed RS may be different.

In some implementations, the first multi-port beamformed RS and the second multi-port beamformed RS may be transmitted via a same TXRU of the network apparatus 720.

In some implementations, the first multi-port beamformed RS and the second multi-port beamformed RS may be transmitted via different TXRUs of the network apparatus 720.

In some implementations, the spatial domain profile may comprise at least one of an indication of at least one DFT vector, an indication of the at least one DFT vector with its associated channel gain, an indication of the at least one DFT vector with co-phasing information on cross-polarization antennas and an angle of departure associated with the at least one channel.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of an apparatus, a beamformed reference signal (RS) from a network node;
determining, by the processor, channel information regarding at least one channel between the network node and the apparatus according to the beamformed RS and based on a pre-determined beamformer used for transmitting the beamformed RS;
determining, by the processor, channel feedback information associated with the at least one channel according to the channel information regarding the at least one channel; and
reporting, by the processor, the channel feedback information to the network node.

2. The method of claim 1, wherein the beamformed RS is a multi-port beamformed RS, and wherein the channel information regarding the at least one channel comprises information regarding multiple channels between the network node and the apparatus.

3. The method of claim 2, wherein the channel information regarding the at least one channel is determined based on a first beamformer applied to a first subset of antenna elements of the network node and associated with a first port of the multi-port beamformed RS and a second beamformer applied to a second subset of antenna elements of the network node and associated with a second port of the multi-port beamformed RS.

4. The method of claim 3, wherein the first beamformer is different from the second beamformer.

5. The method of claim 3, wherein the first subset of antenna elements and the second subset of antenna elements are identical subset of antenna elements within an antenna array.

6. The method of claim 3, wherein the first port and the second port of the multi-port beamformed RS are scheduled on orthogonal resources.

7. The method of claim 6, wherein the orthogonal resources comprise at least one of time division multiplexed resources, frequency division multiplexed resources and code division multiplexed resources.

8. The method of claim 1, wherein the beamformed RS is a first multi-port beamformed RS, the channel information regarding the at least one channel is first channel information determined according to the first multi-port beamformed RS and based on a first beamformer associated with the first multi-port beamformed RS, and the channel feedback information is first channel feedback information determined according to the first channel information, and wherein the method further comprises:
measuring, by the processor, a second multi-port beamformed RS from the network node,
determining, by the processor, second channel information regarding at least one channel between the network node and the apparatus according to the second multi-port beamformed RS and based on a second beamformer associated with the second multi-port beamformed RS;
determining, by the processor, second channel feedback information associated with the at least one channel according to the second channel information; and
reporting, by the processor, the second channel feedback information to the network node,
wherein the first beamformer and the second beamformer are different.

9. The method of claim 8, wherein a size of a first antenna array of the network node used for transmitting the first multi-port beamformed RS and a size of a second antenna array of the network node used for transmitting the second multi-port beamformed RS are different.

10. The method of claim 1, wherein the channel feedback information comprises at least one of an indication of at least one Direct Fourier Transform (DFT) vector, an indication of the at least one DFT vector with its associated channel gain, an indication of the at least one DFT vector with co-phasing information on cross-polarization antennas and an angle of departure associated with the at least one channel.

11. A method, comprising:
transmitting, by a processor of a network node, a first beamformed reference signal (RS) to a communication apparatus; and
receiving, by the processor, first channel feedback information associated with the first beamformed RS from the communication apparatus,
wherein the first beamformed RS is a multi-port beamformed RS generated based on a pre-determined beamformer, and wherein the first channel feedback information comprises a spatial domain profile of multiple channels between the network node and the communication apparatus.

12. The method of claim 11, further comprising:
applying, by the processor, a first beamformer to a first subset of antenna elements, wherein the first beamformer is associated with a first port of the multi-port beamformed RS; and
applying, by the processor, a second beamformer to a second subset of antenna elements, wherein the second beamformer is associated with a second port of the multi-port beamformed RS, and wherein the first beamformer is different from the second beamformer.

13. The method of claim 12, wherein the first subset of antenna elements and the second subset of antenna elements are identical subset of antenna elements within an antenna array.

14. The method of claim 12, wherein at least one antenna element in the first subset of antenna elements is different from at least one antenna element in the second subset of antenna elements.

15. The method of claim 12, further comprising:
scheduling, by the processor, the first port and the second port of the multi-port beamformed RS on orthogonal resources,
wherein the orthogonal resources comprise at least one of time division multiplexed resources, frequency division multiplexed resources and code division multiplexed resources.

16. The method of claim 11, wherein the first beamformed RS is a first multi-port beamformed RS and the first channel feedback information is associated with the first multi-port beamformed RS, and wherein the method further comprises:
transmitting, by the processor, a second multi-port beamformed RS to the communication apparatus; and
receiving, by the processor, second channel feedback information associated with the second multi-port beamformed RS from the communication apparatus,
wherein a first beamformer associated with the first multi-port beamformed RS and a second beamformer associated with the second multi-port beamformed RS are different.

17. The method of claim 16, wherein a size of a first antenna array used for transmitting the first multi-port beamformed RS and a size of a second antenna array used for transmitting the second multi-port beamformed RS are different.

18. The method of claim 16, wherein the first multi-port beamformed RS and the second multi-port beamformed RS are transmitted via a same transmit radio unit (TXRU) of the network node.

19. The method of claim 16, wherein the first multi-port beamformed RS and the second multi-port beamformed RS are transmitted via different transmit radio units (TXRUs) of the network node.

20. The method of claim 11, wherein the spatial domain profile comprises at least one of an indication of at least one Direct Fourier Transform (DFT) vector, an indication of the at least one DFT vector with its associated channel gain, an indication of the at least one DFT vector with co-phasing information on cross-polarization antennas and an angle of departure associated with the at least one channel.
